(19) United States
(12) Patent Application Publication
(10) Pub. No.: US 2011/0302961 A1
(43) Pub. Date: Dec. 15, 2011

(54) METHOD AND AUXILIARY DEVICE FOR PRODUCING FOAM GLASS

(75) Inventors: Michael Fraass, Heinsberg (DE); Hartmut Jaques, Zell am Main (DE); Arjen Steiner, Koeln (DE)

(73) Assignee: Schaumglas Global Consulting GmbH, Zell am Main (DE)

(21) Appl. No.: 13/138,058

(22) PCT Filed: Jan. 4, 2010
(86) PCT No.: PCT/DE2010/000003

§ 371 Date: Aug. 19, 2011

(30) Foreign Application Priority Data
Jan. 4, 2009 (DE) 102009003303.3

(51) Int. Cl. C03B 19/08; B65G 47/74; C03B 19/02

(52) U.S. Cl. 65/22; 65/258; 65/269; 294/86.4

(57) ABSTRACT

Task of the invention is a method and the required auxiliary devices for producing foamed glass, in particular for producing foamed glass plate.

The method is characterized by several steps. In step 1, the raw mixture (1) is supplied from a mixture container (2) via an application apparatus (3) and applied to a glass fleece strip (4) in the form of segments (5). The glass fleece strip (4) lies on a linked chain. The application height is adjusted by a wiper (6). In step 2, the segments (5) on the glass fleece strip (4) pass through the expansion oven (7) with various heat zones (8). In step 3 at the end of the expansion oven (7) pre-cooling takes place. The externally hardened segments (5) are tilted onto a cross slide (10) and transported into an annealing lehr (11).

Specific auxiliary devices are an application apparatus (3), a special expansion oven (7) and equipment for transporting foamed glass blocks during the production of foamed glass.

The application area of the invention is the production of foamed glass plates.

Method for producing foamed glass, application apparatus for applying material and expansion oven for producing foamed glass as well as device for transporting foamed glass blocks, in particular in the production of foamed glass plates.

Several methods for producing foamed glass are already known. However, their drawback is the very time-consuming and inefficient implementation. For example, molds are used for the production of plates, which are filled with the respective foam mixture and after expanding have to be demolded again. The cooling takes place only subsequently.

For example, CH 637 606 A5 describes a method for producing foamed glass granulate. The foamed glass granulate consists of fractions of a foamed glass body and has at least 10⁵, preferably at least 10⁶ bubbles per cm3 of at least approximately the same size. This is achieved by grinding the raw materials into a powder, mixing it with a foaming agent that generates gas at temperature, expanding the mixture in a flatbed oven to form a flat foamed glass strand, cooling it after expansion and reducing it to a granulate directly after cooling.

CH 688 549 A5 also describes a method for producing moldings from foamed glass. This method for producing foamed glass moldings, whereby these moldings largely have a closed external skin, is characterized in that, in the first step, glass powder with the respective desired composition of sieve fineness, at least one expanding agent which releases an expanding gas at temperature, and at least one binding agent are mixed to form a homogeneous and compactable mix, and then, in the second step, this homogeneous and compactable mixture is either expanded under temperature to form foamed glass, and then the material, which has been expanded in this way, is molded into the desired shape and size under pressure while still in its heated and viscous condition, this pressure being maintained at least until the surface of the foamed glass has hardened during cooling to the extent that the foamed glass no longer loses its shape, or the stated homogeneous and compactable mixture is formed and compacted to the desired raw body, this shaped and compacted raw body is expanded into glass foam at temperature, and then in a third step the resulting expanded material formed is cooled such that the end product does not contain any stress cracks.

DE 177 14 15 A1 describes a method for producing lightweight construction materials and lightweight aggregates from volcanic tuffs, in which fine or very fine raw material, such as tuff dust or silt is preformed, initially into intermediate bodies, such as a granulate or other moldings, and then heated to around 400° to 500° C. and subsequently heated in the presence of carbon over a short period to a temperature of 800° to 1150° C. and then expanded into the finished foam bodies, whereby the pyroplastic bodies are prevented from sticking together through the addition of a separating agent.

AT 259 783 B describes a method for producing foamed glass, whereby a foamable mixture, made from a fine glass substance and expanding agent(s) is heated to the temperature required for foaming and then cooled, characterized in that a sandwich-like plate, board or strand-like layered body is formed from the mixture produced, preferably with the addition of a colloidal powder, e.g. clay, kaolin, talcum or similar and a material which does not melt at the high temperatures, and is passed with the non-melting layer as a supporting surface through the heating zone.

AT 234 938 B also describes a method for producing heat insulation plates or plates of foamed glass, in which smaller foamed glass pieces are made first in a known method and then a layer of the desired thickness of tightly connected pieces is heated on conveyor device, so that the pieces of glass or their surface layer softens, after which the layer heated in this way is subject to pressure in a continuous track in order to stick the balls together.

DE 195 36 666 C2 describes a method for producing foamed glass using conventional materials and gas-forming materials, in which the conventional materials used, such as glass powder and/or glass fragments, minerals, mixed silicates, glass formers and other material to be foamed are broken or pulverized and fed to an extruder and are melted in the extruder together expanding agents also fed to the extruder, with the supply of extra heat which, in addition to the frictional heat resulting from shear forces and rubbing together and mixing of the charged material, produces the temperature required to achieve the change from glass powder and/or glass fragments, minerals, mixed silicates, glass formers and other material to be foamed to molten glass, and after thorough mixing and melting of the components, the foamed molten glass and/or foamed glass is poured into a mold or onto a conveyor device with finishes.

Finally, DE 302 27 87 A1 describes a method for the continuous production of foamed glass in which glass power and expanding agent are heated on a carbon base and are fully or partly solidified with a specific additive recipe through drying and/or through other binding, are left to stand for a period of at least 10 minutes and then the solidified mixture is granulated and the granulated glass mass is distributed in layers on a conveyor belt made from heat-resistant material such as wire or similar, on which a separating agent has previously been applied in order to prevent the glass mass from sticking to it, and then the glass mass is transported on the conveyor belt through a furnace, in which the glass mass is melted, expanded and then at least partly cooled.

The task of the invention is to create a method, apparatus for applying material and an expansion oven for producing foamed glass as well as a device for conveying foamed glass blocks during the production process.

In this application case, the invention achieves the creation of a method and several auxiliary devices, achieving a high level of material utilization and high degree of automation. Plates of differing lengths and differing adjustable heights across the width of the fleece strip can be produced as a result of the glass fleece strip and the wiper. As a result of the method according to the invention, production is simplified and accelerated, as additional filling steps and demolding steps are omitted. The necessary energy-intensive heating of molds is omitted, along with the slow cooling of the molds. The entire process is therefore cheaper and can be completed in shorter periods. Because of the formation of segments, extensive processing of the foamed glass directly after the expansion oven is no longer necessary. In the invention, the segments are cooled in an entirely automatic process.

The pre-cooled segments are positioned vertically by the positioning device. With the pre-cooling, the segments receive the necessary externally solid structure. Through the automated post-processing of the cooled plates or blocks, almost any shape can be produced without requiring special molds or molding process steps for the raw mixture.

Advantageous configurations of the invention are shown in Claims 2 to 14.

According to Claim 2, the method experiences further improvement in a 4th step where the expanded and cooled segments are fed to a post-processing, whereby the segments are given the desired shape and size.

With the improvement according to Claim 3, the processed segments are logistically processed in a 5th step, whereby they become suitable for storage as well as suitable and ready for shipment.

The improvement according to Claim 4 is an expansion of step 5, in which additional safety devices are positioned around and on the segments, protecting them against mechanical influences.

In the improvement according to Claim 5, a wiper is lowered and raised in order to prevent continuous bands and to form differently sized and/or long segments. In addition, the application height of the raw mixture can be adjusted extremely precisely for the expected height of the expanded segment. Depending on the application height, different distances between the individual segments can be produced.

According to Claim 6, a vibration element is activated or deactivated on the wiper, whereby the raw mixture is better homogenized on the glass fleece and therefore can be adjusted to the various glass powder qualities and quality requirements for the end product.

With the improvement according to Claim 7, the foamed or expanded segments are fed into the annealing lehr upright, parallel next to each other in order to reduce the length of the annealing lehr and simultaneously to increase the yield.

For quality assurance, according to Claim 8 the segments are cooled in the annealing lehr in a defined unstressed way.

According to Claim 9, the glass fleece strip remains on the lower side of the segments. As a result of the defined surface created by this, the blocks or plates can subsequently be fixed or mounted to corresponding surfaces by means of suitable methods. This reduces the sides to be processed in the post-processing.

With the improvement according to Claim 10 as a secondary claim, the application apparatus has a wiper with a vibration element. This separates the segments and the raw mixture is applied to the glass fleece in a better homogenized stated in order to achieve the quality.

The height positioning device and/or angle positioning device on the wiper according to Claim 11 serves to separate the segments from the raw mixture and to set the application height of the raw mixture precisely according to the requirements.

The specific design of the expansion oven according to Claim 12 as secondary claim allows energy to be used efficiently. By circulating the thermal energy supplied, the tempering of the segments to be foamed or expanded is uniform.

According to Claim 13, the glass fleece strip is fed into the expansion oven by means of a link chain, whereby the raw mixture is pulled through the expansion oven and transported on a consistently flat surface and can easily be removed again after expanding and pre-cooling.

The hedgehogs and/or robots on the positioning device according to Claim 14 guarantee reliable gripping of the segments on the already hard external shell without endangering the still unstable inner structure.

Several design examples of the invention are shown in the drawings and are described in more detail below.

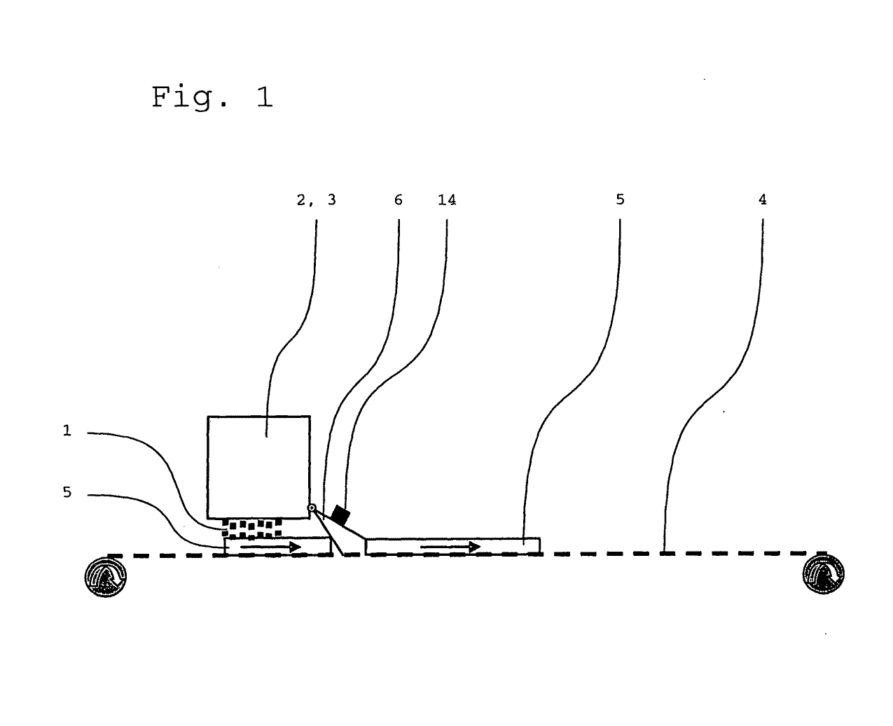

FIG. 1 shows a schematic representation of the raw mixture feed and segment formation,

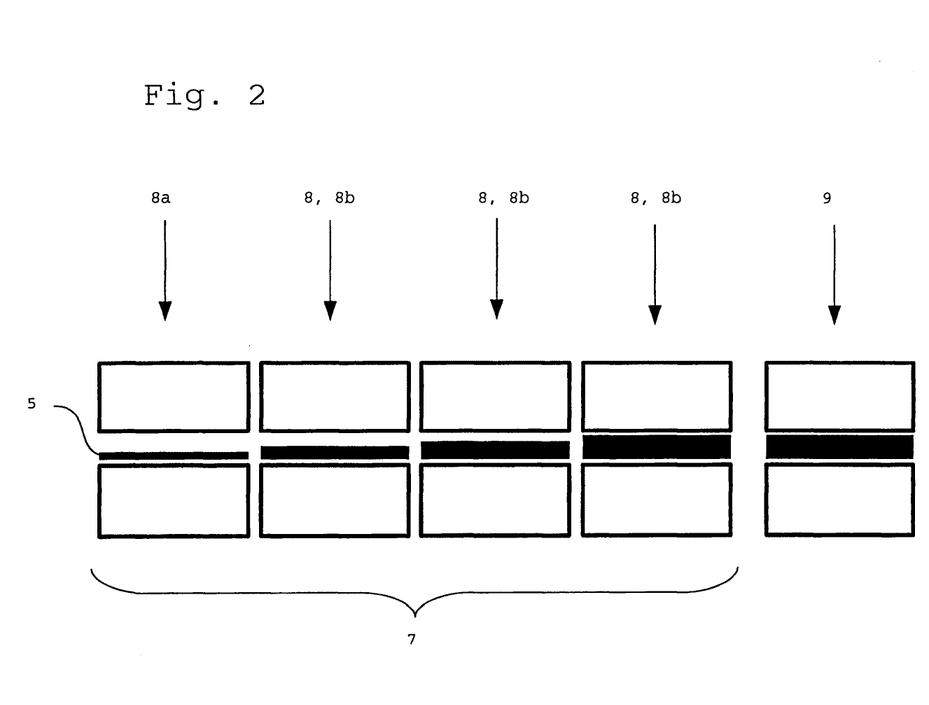

FIG. 2 shows a schematic representation of an expansion oven line with different heat zones and a stabilization area at the end of the heat zone line in the expansion oven,

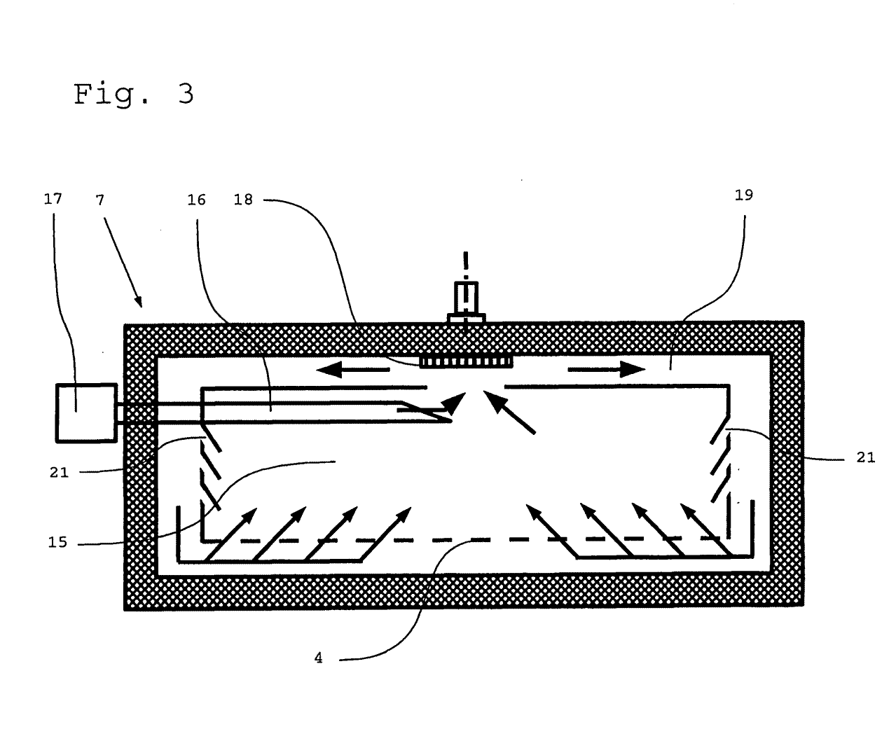

FIG. 3 shows a schematic representation of the cross-section of an expansion oven,

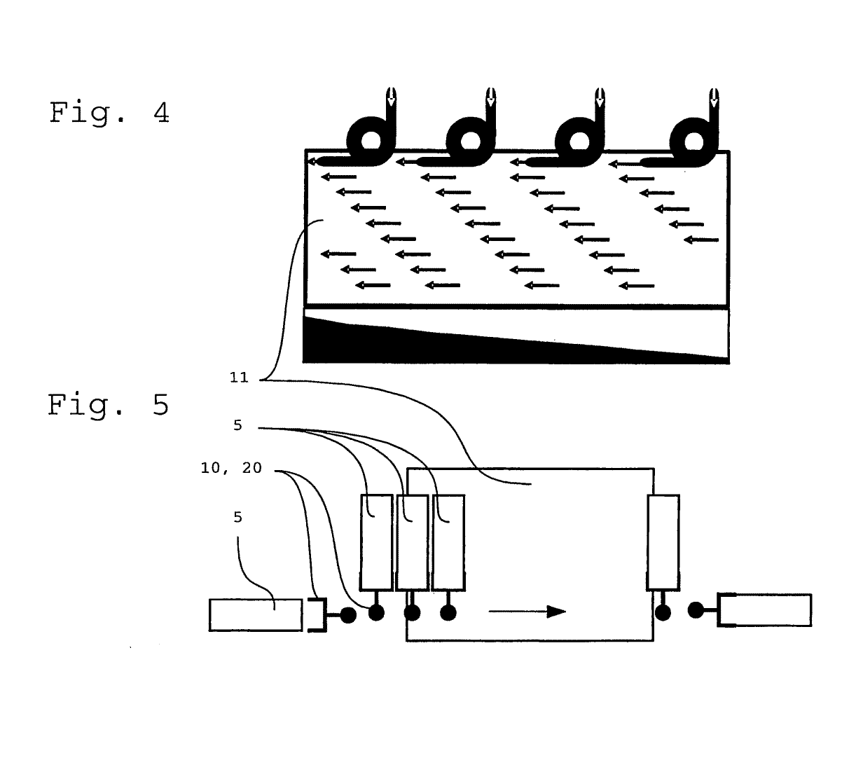

FIG. 4 shows a schematic representation of the air flow in an annealing lehr with the development of the temperature,

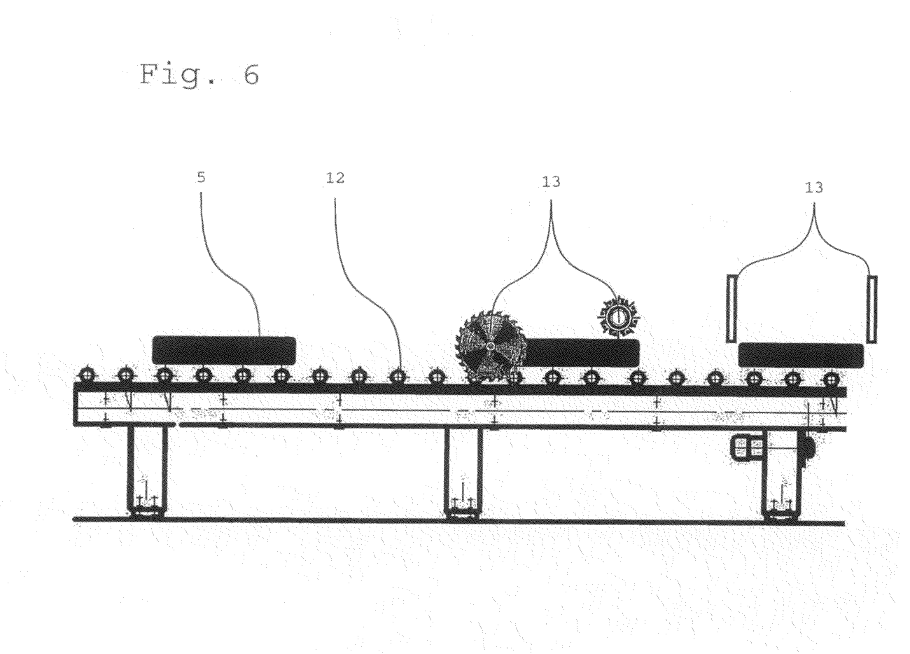

FIG. 5 shows a schematic representation of the cooling with annealing lehr,

FIG. 6 shows a schematic representation of the post-processing process.

The method according to the invention is implemented through the individual process steps. In step 1, as shown schematically in FIG. 1, a known and homogenously mixed recipe is applied as a raw mixture 1 to a glass fleece strip 4, which is positioned on a circulating linked chain. The raw mixture 1 is applied using the application apparatus 3 with consistent brush strokes. The brush ensures consistent application of the material over the entire application width. The raw mixture 1 is divided into segments 5 with a wiper 6. The application height of the raw mixture 1 is adjusted precisely to the millimeter by the wiper 6. To this end, the wiper 6 is raised and lowered correspondingly. The correspondingly controlled lowering and raising is carried out in the same way to separate the segments 5 in order to prevent endless bands. Depending on the application height, the distance between the segments 5 is set longer or shorter. To this end, the wiper 6 has a controlled height positioning device. The raw mixture 1 is applied to the entire width of the glass fleece strip 4. To better homogenize the raw mixture 1 on the glass fleece strip 4, vibration elements 14 are fitted to the wiper 6. These can be activated when required. This allows quality requirements to be met individually. In the second invention step, as shown schematically in FIG. 2, the segments 5 are transported on the glass fleece strip 4 into the expansion oven 7. The segments 5 pass through several consecutive heat zones 8. After the entrance area 8a, they pass the foaming areas 8b. In step 3, as shown in FIGS. 4 and 5, the pre-cooling takes place at the end of the expansion oven 7 after the last foaming area 8b in a stabilization area 9 in order to harden the outer layer. The glass fleece strip 4 remains on the segments 5 after the foaming process and subsequently on the finished blocks or plates if required after the post-processing 13. This surface can be used to fix the plates to building facades by means of special adhesives. The lying segments 5 are moved into a vertical position in a cross slide 10 at the end of the stabilization area 9 using a positioning device 20, and are fed into an annealing lehr 11 with these cross slides 10. The segments 5 pass through the annealing lehr 11 in parallel. This minimizes the length of the annealing lehr 11. In the annealing lehr 11, the segments 5 are cooled in a defined unstressed way. In step 4, as shown in FIG. 6, after the annealing lehr 11 the segments 5 are forwarded for post-processing 13. The segments are formed into the desired shape here by milling or cutting. Simple cutting and flat milling are just as possible as three-dimensional processing. The post-processing 13 in step 5 is followed by the logistical processing of the finished segments 5. The post-processed segments 5 are stacked on pallets and packaged ready for shipping. To protect, in particular, against mechanical influences, the segments 5 are given corresponding protective device. Steps 1 to 5 are fully automated as an inline process. Intervention by staff is reduced to a very small amount.

The expansion oven 7 is shown schematically in FIG. 3. In cross-section, it mainly comprises a rectangular combustion chamber 15. The combustion chamber 15 is shaped like an inner hood with an open bottom. On the long sides at the top of the combustion chamber are burner pipes 16 and/or burner nozzles 16. These burner pipes 16 have a beveled, curved and/or bent outlet facing towards the top. In this example, the burner 17 is located within the expansion oven 7. An opening is located in the middle of the top of the combustion chamber 15. This opening allows access and passage to the flow channel 19 surrounding the combustion chamber 15. A converter 18 in the form of an impeller and/or blade wheel is located above the opening to the combustion chamber. The flow channel 19 has openings 21 on the side of the interior of the expansion oven 7 in the form of gills. For energy efficiency, the flow channel 19 is surrounded on all sides by an insulating wall that separates it from the expansion oven 7. The combustion chamber 15 is separated from the glass fleece strip 4 at the bottom.

Grippers are located on a positioning device 20 at the end of the stabilization area 9, preferably in the form of hedgehogs and/or robots. The grippers on the positioning device 20 grip the segments 5 and position these vertically.

### LIST OF REFERENCES

1—Raw mixture
2—Mixture container
3—Application apparatus
4—Glass fleece strip, glass fleece segment
5—Segment
6—Wiper
7—Expansion oven
8—Heat zones
8a—Entrance area
8b—Foaming area
9—Stabilization area
10—Cross slides
11—Annealing lehr
12—Conveyor device
13—Post-processing
14—Vibration element
15—Combustion chamber
16—Combustion pipe, combustion nozzle
17—Burner
18—Converter
19—Flow channel
20—Positioning device
21—Opening

1. Method for producing foamed glass, whereby a homogenously mixed mixture according to a known recipe is supplied to the processing process, heating for foaming and then cooled, wherein
in step 1, a raw mixture (1) is supplied from a mixture container (2) via an application apparatus (3) and applied with consistent brush strokes to a glass fleece strip (4) and/or glass fleece segment (4), which is already positioned on a circulating linked chain, whereby the raw mixture (1) is divided into segments (5) in the form of blocks and/or plates across the entire width of the glass fleece strip (4) and/or glass fleece segment (4) and the supply height is adjusted using a wiper (6),
in step 2 the segments (5) on the glass fleece strip (4) and/or glass fleece segment (4) pass through the expansion oven (7) and various heat zones (8), whereby the segments (5) consecutively pass through an entrance area (8a) and at least one foaming area (8b),
in step 3 at the end of the expansion oven (7) there is pre-cooling in a stabilization area (9) and the exiting segments (5) are tipped into a vertical position by a positioning device (20) onto a cross slide (10) and are then transported into an annealing lehr (11), whereby the positioning device (20) hooks into and/or grips the surface of the segments (5) and positions the segments (5) on the cross slides (10).

2. Method according to claim 1, wherein
in step 4 at the end of the annealing lehr (11) the segments (5) are repositioned horizontally on a conveyor device (12) and transported to post-processing (13) in the form of known cutting devices and/or milling devices, whereby a horizontal, vertical and/or any three-dimensional post-processing (13) is performed.

3. Method according to any of claim 1, wherein
in step 5 the post-processed segments (5) are stacked on pallets and/or in storage space using a stacker and are protectively packaged in stretch film.

4. Method according to ally of above claims, claim 1, wherein
in step 5, the edges of the segments (5) are additionally protected with edge protectors.

5. Method according to above claim claim 1, wherein
as a result of interrupted application of the raw mixture (1) and by lowering and raising the wiper (6), the segments (5) in step 1 are formed.

6. Method according to claim 1, wherein
in step 1 the wiper (6) is fitted with a vibration element (14).

7. Method according to claim 1, wherein
in step 3 the segments (5) are positioned parallel to each other in the annealing lehr (11).

8. Method according to claim 1, wherein
the cooling in step 3 is a defined unstressed process.

9. Method according to claim 1, wherein
the glass fleece strip (4) and/or the glass fleece segment (4) remains on the bottom of the segments (5) and in step 3 the glass fleece strip (4) is separated between the individual segments (5).

10. Application apparatus for applying the material for producing foamed glass, wherein
at the end of the supply arrangement (3) in the working direction of the linked chain there is a wiper (6) in the form of a shutter and/or comb with a vibration element (14).

11. Application apparatus according to claim 10, wherein
the wiper (6) has a height positioning device and/or angle positioning device, with controls for the positioning devices.

12. Expansion oven for producing foamed glass, wherein
there is a combustion chamber (15) with a largely rectangular cross section in the form of an inner hood with an open bottom and wherein at least one of the vertical long sides in the combustion chamber has burner pipes (16) and/or burner nozzles (16), these having a beveled, bent and/or curved outlet facing to the top and the burner (17) being located inside and/or outside the expansion oven (7) and wherein there is an opening in the middle of the top of the combustion chamber (15) to the surrounding flow channel (19), whereby a converter (18) in the form of an impeller and/or blade wheel is fitted and the flow channel (19) has an opening (21) to the side of the interior of the expansion oven (7) in the form of gills and wherein the flow channel (19) is surrounded on all sides by a wall separating it and insulating it from the expansion oven (7) and
wherein the combustion chamber (15) is separated at the bottom by a glass fleece strip (4).

13. Expansion oven according to claim 12, wherein
the glass fleece strip (4) can be fed via a linked chain along the application apparatus (3) and/or into the expansion oven (7).

14. Device for transporting foamed glass blocks when producing foamed glass, wherein
gripper elements in form of hedgehogs and/or robots are fitted to a positioning device (20) at the end of the stabilization area (9).
